(19) United States
(12) Patent Application Publication
(10) Pub. No.: US 2025/0047309 A1
(43) Pub. Date: Feb. 6, 2025

(54) Integrated Sensing and Communication Using Neural Networks

(71) Applicant: Micron Technology, Inc., Boise, ID (US)

(72) Inventors: Fa-Long LUO, San Jose, CA (US); Jaime CUMMINS, Bainbridge Island, WA (US)

(73) Assignee: Micron Technology, Inc., Boise, ID (US)

(21) Appl. No.: 18/583,704

(22) Filed: Feb. 21, 2024

Related U.S. Application Data
(60) Provisional application No. 63/487,570, filed on Feb. 28, 2023.

(51) Int. Cl. H04B 1/00; H04W 52/02

(52) U.S. Cl. CPC H04B 1/0028; H04W 52/0216

(57) ABSTRACT

A wireless device includes a sensor configured to receive input data, an antenna configured to transmit a radio frequency (RF) signal that is based at least in part on the input data, and one or more processing units coupled with the sensor and operable, during an active time period, to process the input data using a single neural network for a plurality of processing stages. The plurality of processing stages including a source data processing stage and communication processing stages.

### CROSS REFERENCE TO RELATED APPLICATION(S)

This application claims the benefit under 35 U.S.C. § 119 of the earlier filing date of U.S. Provisional Application Ser. No. 63/487,570 filed Feb. 28, 2023, the entire contents of which are hereby incorporated by reference in their entirety for any purpose.

### BACKGROUND

Digital signal processing for wireless communications, such as digital baseband processing or digital front end implementations, may be implemented using hardware (e.g. silicon) computing platforms. For example, multimedia processing and digital radio frequency (RF) processing may be accomplished by an application-specific integrated circuit (ASIC) which may implement a digital front end for a wireless transceiver. A variety of hardware platforms are available to implement digital signal processing, such as the ASIC, a digital signal processor (DSP) implemented as part of a field-programmable gate array (FPGA), or a system-on-chip (SoC). However, each of these solutions often requires implementing customized signal processing methods that are hardware-implementation specific. For example, a digital signal processor may implement a specific portion of digital processing at a cellular base station, such as filtering interference based on the environmental parameters at that base station. Each portion of the overall signal processing performed may be implemented by different, specially-designed hardware, creating complexity.

### BRIEF DESCRIPTION OF DRAWINGS

FIG. 1 is a block diagram of a computing system arranged in accordance with examples described herein.

FIG. 2 is a block diagram of a computing system arranged in accordance with the example of FIG. 1.

FIG. 3 is a timing diagram of an electronic device arranged in accordance with examples described herein.

FIG. 4 is a schematic illustration of a computing system arranged in accordance with examples described herein.

FIG. 5 is a flowchart of a method arranged in accordance with examples described herein.

FIG. 6 is another flowchart of a method arranged in accordance with examples described herein.

FIG. 7 is a block diagram of a wireless communications system arranged in accordance with aspects of the present disclosure.

FIG. 8 is a block diagram of another wireless communications system arranged in accordance with aspects of the present disclosure.

### DETAILED DESCRIPTION

Certain details are set forth below to provide a sufficient understanding of embodiments of the present disclosure. However, it will be clear to one skilled in the art that embodiments of the present disclosure may be practiced without various of these particular details. In some instances, well-known wireless communication components, circuits, control signals, timing protocols, computing system components, and software operations have not been shown in detail in order to avoid unnecessarily obscuring the described embodiments of the present disclosure.

Examples described herein include integration of source data and communication processing. In some examples, a source data processing stage may include processing of sensor or source data (e.g., video, image, audio, temperature, pressure, acceleration, other sensor encoders or decoders) received from a sensor or other source data device. To communicate the source data, it may be passed through various communication processing stages (e.g., baseband, digital RF processing stages) for transmission to a user or subscriber to the data. By integrating the source data processing with the communication processing into one step, the processing may be more time and resource efficient as compared with separate processing stages for each. For example, having different stages for source data processing and communication data processing may include different processors and chips, which may add to the complexity and cost of the wireless communication devices. By combining the source data processing and communication processing may be able to reduce the complexity and cost of such devices.

Wireless communication devices (e.g., in multiple input multiple output (MIMO) systems) may implement integrated sensing and communication processing stages using neural networks. For example, a source data processing stage may be combined with communication processing stages (e.g., baseband, digital front end, RF processing stages) in a single neural network. Source data processors may include video encoders/decoders, image encoders/decoders, audio encoders/decoders, and the like. Using a neural network to implement a source data processing stage may facilitate a more versatile system that allows configuration of multiple different source data processor types by changing the configuration of the neural network (e.g., rather than having a dedicated source data processor for each source data type). Integrating the source data processing stage with the communication processing stages may allow greater configurability across different source data types and different communication protocols without having to change hardware.

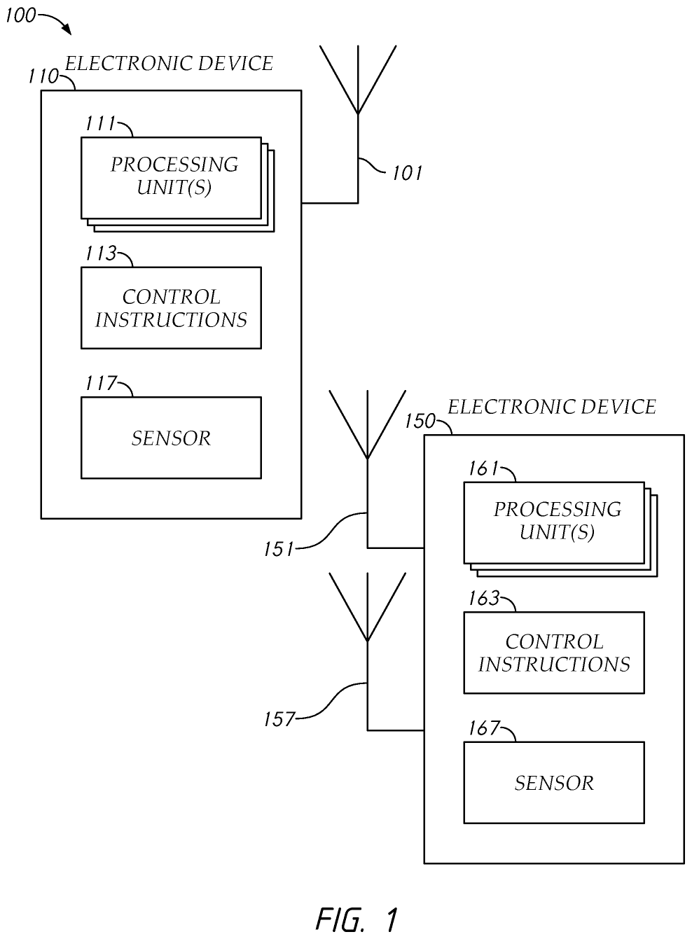

FIG. 1 is a block diagram of a wireless communications system arranged in accordance with examples described herein. Computing system 100 includes electronic device 110 and electronic device 150. The electronic device 110, coupled to the antenna 101, includes a sensor 117. The electronic device 110, which may be implemented on a reconfigurable fabric, includes processing units 111 and control instructions 113. The control instructions 113 may be stored on non-transitory computer readable media, for example, as encoded executable instructions, which, when executed by a processor (e.g., a reconfigurable fabric), is configured to cause the electronic device 110 to perform certain operations described herein. The electronic device 110 may be in communication with antennas 101 to transmit or receive wireless communication signals, for example, modulated RF signals on a specific wireless band.

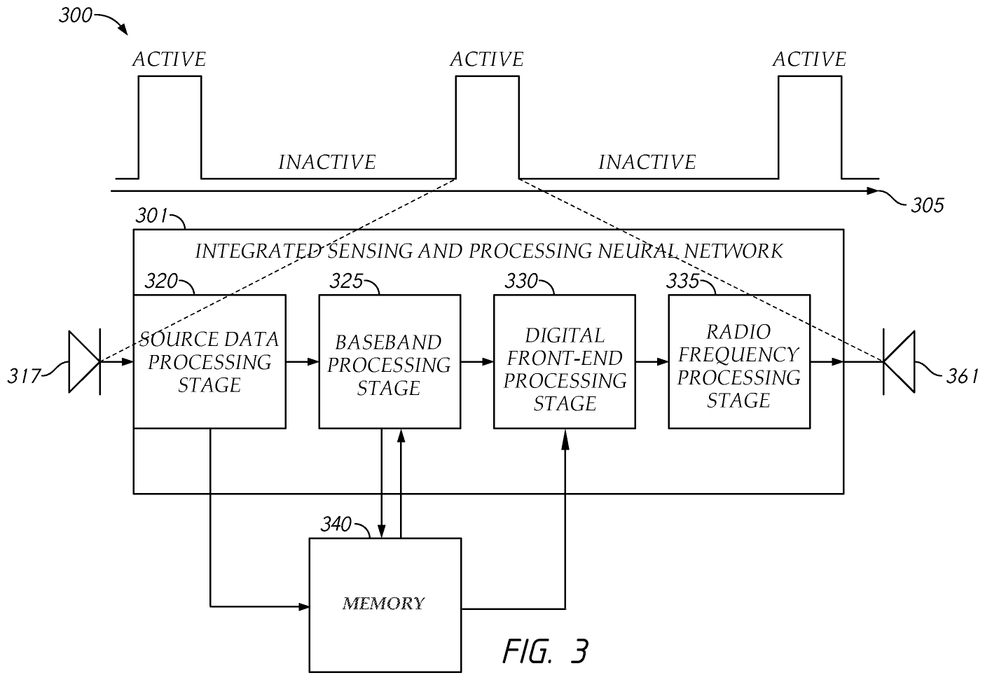

The electronic device 150, coupled to the antennas 151, 157, includes a sensor 167. The electronic device 150, which may also be implemented on a reconfigurable fabric, includes processing units 161 and control instructions 163. The control instructions 163 may be stored on non-transitory computer readable media, for example, as encoded executable instructions, which, when executed by a processor (e.g. a reconfigurable fabric), is configured to cause the electronic device 150 to perform certain operations described herein. The electronic device 150 may be transmitting or receiving on the same wireless band as the electronic device 110 or on a different wireless band. Control instructions 113, 163 may configure the respective electronic devices 110, 150 for specific configurations. Control instructions 113 and 163 may be locally implemented on each electronic device 110, 150. The electronic devices 110, 150 may utilize the respective control instructions 113, 163 to control the respective antenna 101 and antennas 151, 157; and, to control the respective sensors 117, 167. In other examples, fewer, additional, and/or different components may be provided. For example, while described above with each electronic device including a single sensor, in other examples, multiple sensors may be included in each electronic device 110, 150. Or, as depicted in FIG. 3, either electronic device 110 or electronic device 150 may include a memory such as memory 340.

Electronic devices described herein, such as electronic device 110 and electronic device 150 shown in FIG. 1 may be implemented using generally any electronic device for which wireless communication capability is desired. For example, electronic device 110 and/or electronic device 150 may be implemented using a mobile phone, smartwatch (or other wearable device), computer (e.g. server, laptop, tablet, desktop), or radio. In some examples, the electronic device 110 and/or electronic device 150 may be incorporated into and/or in communication with other apparatuses for which communication capability is desired, including devices associated with the Internet of Things (IoT), such as but not limited to, an automobile, airplane, helicopter, appliance, tag, camera, or other device. While not explicitly shown in FIG. 1, electronic device 110 and/or electronic device 150 may include any of a variety of components in some examples, including, but not limited to, memory, input/output devices, circuitry, processing units (e.g. processing elements and/or processors), or combinations thereof.

The electronic device 110 and the electronic device 150 may each include multiple antennas. For example, the electronic device 110 and electronic device 150 may each have more than two antennas. While electronic device 110 includes one antenna and electronic device 150 includes two antennas, generally any number of antennas may be used including 2, 3, 4, 5, 6, 7, 8, 9, 10, 11, 12, 13, 14, 15, 16, 32, 64, or 96 antennas. Other numbers of antennas may be used in other examples. In some examples, the electronic device 110 and electronic device 150 may have a same number of antennas. In other examples, the electronic device 110 and electronic device 150 may have different numbers of antennas, as shown in FIG. 1. Generally, systems described herein may include MIMO systems.

MIMO systems generally refer to systems including one or more electronic devices which transmit transmissions using multiple antennas and one or more electronic devices which receive transmissions using multiple antennas. In some examples, electronic devices may both transmit and receive transmissions using multiple antennas. Some example systems described herein may be “massive MIMO” systems. Generally, massive MIMO systems refer to systems employing greater than a certain number (e.g. 96) antennas to transmit and/or receive transmissions. As the number of antennas increase, so generally does the complexity involved in accurately transmitting and/or receiving transmissions. Although two electronic devices (e.g. electronic device 110 and electronic device 150) are shown in FIG. 1, generally the system 100 may include any number of electronic devices.

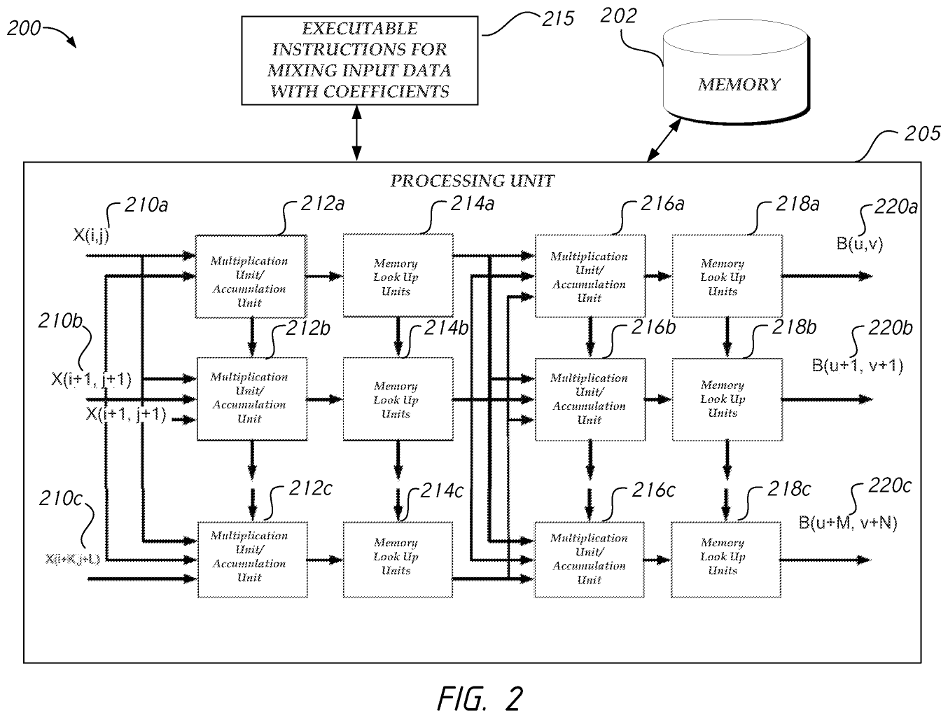

Each of the processing unit(s) 111, 161 may be implemented using one or more operand processing units, such as an arithmetic logic unit (ALU), a bit manipulation unit, a multiplication unit, an accumulation unit, an adder unit, a look-up table unit, a memory look-up unit, or any combination thereof. In some examples, each of the processing unit(s) 111, 161 may include circuitry, including custom circuitry, and/or firmware for performing functions described herein. For example, circuitry can include multiplication unit/accumulation units for performing the described functions, as described herein. Each of the processing unit(s) 111, 161 can be implemented as a microprocessor or a digital signal processor (DSP), or any combination thereof. For example, processing unit(s) 111, 161 can include levels of caching, such as a level one cache and a level two cache, a core, and registers. Examples of processing unit(s) 111, 161 are described herein, for example with reference to FIG. 2.

Sensor 117 or sensor 167 may each individually be any type of sensor for monitoring and/or detecting changes in environmental conditions of the respective electronic device 110 or electronic device 150, which may be referred to as environmental characteristics of each respective electronic device 110 or electronic device 150. For example, sensor 117 or sensor 167 may monitor environmental conditions of their surroundings utilizing mechanisms of the sensor to detect or monitor changes to that environment. Various detecting mechanisms may be utilized by the sensors, 117, 167 including, but not limited to mechanisms that are electrical, chemical, mechanical, or any combination thereof. For example, the sensor 117 may detecting changes in a road or building structure utilizing a mechanical actuator that translates energy into an electrical signal. As another example, sensor 167 may detect changes in a sugar level of the blood utilizing a chemical sensor that translates energy into an electrical signal. Various types of sensors, for example any type of sensor that may be utilized in an electronic device and coupled to a processing unit 111, 161.

FIG. 2 is a block diagram of a processing unit 205 arranged in a computing system 200 in accordance with examples described herein. The system 200 may be the electronic device 110 or electronic device 150, for example. The processing unit 205 may receive input data (e.g. X (i,j)) 210a-c from such a computing system. In some examples, the input data 210a-c may be input data, such as data received from a sensor or data stored in the memory 202. For example, data stored in the memory 202 may be output data generated by one or more processing units implementing another processing stage. The processing unit 205 may include multiplication unit/accumulation units 212a-c, 216a-c and memory lookup units 214a-c, 218a-c that, when mixed with weight data retrieved from the memory 202, may generate output data (e.g. B (u,v)) 220a-c. In some examples, the output data 220a-c may be utilized as input data for another processing stage or as output data to be transmitted via an antenna.

In implementing one or more processing units 205, a computer-readable medium at an electronic device 110, 150 may execute respective control instructions 113 and control instructions 163 to perform operations through executable instructions 115 within a processing unit 205. For example, the control instructions 113 provide instructions to the processing unit 205, that when executed by the computing device 110, cause the processing unit 205 to configure the multiplication units 212a-c to multiply input data 210a-c with weight data and accumulation units 216a-c to accumulate processing results to generate the output data 220a-c.

The multiplication unit/accumulation units 212a-c, 216a-c multiply two operands from the input data 210a-c to generate a multiplication processing result that is accumulated by the accumulation unit portion of the multiplication unit/accumulation units 212a-c, 216a-c. The multiplication unit/accumulation units 212a-c, 216a-c adds the multiplication processing result to update the processing result stored in the accumulation unit portion, thereby accumulating the multiplication processing result. For example, the multiplication unit/accumulation units 212a-c, 216a-c may perform a multiply-accumulate operation such that two operands, M and N, are multiplied and then added with P to generate a new version of P that is stored in its respective multiplication unit/accumulation units. The memory look-up units 214a-c, 218a-c retrieve weight data stored in memory 202. For example, the memory look-up unit can be a table look-up that retrieves a specific weight. The output of the memory look-up units 214a-c, 218a-c is provided to the multiplication unit/accumulation units 212a-c, 216a c that may be utilized as a multiplication operand in the multiplication unit portion of the multiplication unit/accumulation units 212a-c, 216a-c. Using such a circuitry arrangement, the output data (e.g. B (u,v)) 220a-c may be generated from the input data (e.g. X (i,j)) 210a-c.

In some examples, weight data, for example from memory 202, can be mixed with the input data X (i,j) 210a-c to generate the output data B (u,v) 220a-c. The relationship of the weight data to the output data B (u,v) 220a-c based on the input data X (i,j) 210a-c may be expressed as:

$$B ( u , v ) = f ( {\sum }_{m , n}^{M , N} {a}_{m , n}^{″} f ( {\sum }_{k , l}^{K , L} {a}_{k , l}^{′} X ( i + k , j + l ) ) ) \qquad ( 1 )$$

where a′_{k,l}, a″_{m,n} are weights for the first set of multiplication/accumulation units 212a-c and second set of multiplication/accumulation units 216a-c, respectively, and where f(·) stands for the mapping relationship performed by the memory look-up units 214a-c, 218a-c. As described above, the memory look-up units 214a-c, 218a-c retrieve weights to mix with the input data. Accordingly, the output data may be provided by manipulating the input data with multiplication/accumulation units using a set of weights stored in the memory associated with a desired wireless protocol. The resulting mapped data may be manipulated by additional multiplication/accumulation units using additional sets of weights stored in the memory associated with the desired wireless protocol. The sets of weights multiplied at each stage of the processing unit 205 may represent or provide an estimation of the processing of the input data in specifically-designed hardware (e.g., an FPGA).

Further, it can be shown that the system 200, as represented by Equation 1, may approximate any nonlinear mapping with arbitrarily small error in some examples and the mapping of system 200 is determined by the weights a′_{k,l}, a″_{m,n}. For example, if such weight data is specified, any mapping and processing between the input data X (i,j) 210a-c and the output data B (u,v) 220a-c may be accomplished by the system 200. Such a relationship, as derived from the circuitry arrangement depicted in system 200, may be used to train an entity of the computing system 200 to generate weight data. For example, using Equation (1), an entity of the computing system 200 may compare input data to the output data to generate the weight data.

In the example of system 200, the processing unit 205 mixes the weight data with the input data X (i,j) 210a-c utilizing the memory look-up units 214a-c, 218a-c. In some examples, the memory look-up units 214a-c, 218a-c can be referred to as table look-up units. The weight data may be associated with a mapping relationship for the input data X (i,j) 210a-c to the output data B (u,v) 220a-c. For example, the weight data may represent non-linear mappings of the input data X (i,j) 210a-c to the output data B (u,v) 220a-c. In some examples, the non-linear mappings of the weight data may represent a Gaussian function, a piece-wise linear function, a sigmoid function, a thin-plate-spline function, a multi-quadratic function, a cubic approximation, an inverse multi-quadratic function, or combinations thereof. In some examples, some or all of the memory look-up units 214a-c, 218a-c may be deactivated. For example, one or more of the memory look-up units 214a-c, 218a-c may operate as a gain unit with the unity gain. In such a case, the instructions 113 or instructions 163 may be executed through 115 to facilitate selection of a unity gain processing mode for some or all of the memory look-up units 214a-c, 218a-c.

Each of the multiplication unit/accumulation units 212a-c, 216a-c may include multiple multipliers, multiple accumulation units, or and/or multiple adders. Any one of the multiplication unit/accumulation units 212a-c, 216a may be implemented using an ALU. In some examples, any one of the multiplication unit/accumulation units 212a-c, 216a-c can include one multiplier and one adder that each perform, respectively, multiple multiplications and multiple additions. The input-output relationship of a multiplication/accumulation unit 212, 216 may be represented as:

$${B}_{out} = {\sum }_{i = 1}^{I} {C}_{i} * {B}_{i n} ( i ) \qquad ( 2 )$$

where “I” represents a number to perform the multiplications in that unit, Cᵢ the weights which may be accessed from a memory, such as memory 202, and Bᵢₙ(i) represents a factor from either the input data X (i,j) 210a-c or an output from multiplication unit/accumulation units 212a-c, 216a-c. In an example, the output of a set of multiplication unit/accumulation units, Bₒᵤₜ, equals the sum of weight data, Cᵢ multiplied by the output of another set of multiplication unit/accumulation units, Bᵢₙ(i), Bᵢₙ(i) may also be the input data such that the output of a set of multiplication unit/accumulation units, Bₒᵤₜ, equals the sum of weight data, Cᵢ multiplied by input data.

FIG. 3 is a timing diagram of an electronic device 300 operating in accordance with examples described herein. The electronic device 300 includes a sensor 317 and antenna 361. The electronic device 300 may be configured to implement various configurations, with each configuration allocating processing units to perform a portion of the data processing on data received from the sensor 317 and to generate output data to be transmitted at the antenna 361 as an RF signal. Electronic devices being implemented as electronic device 300, which may include processing units (e.g., processing units 111 of electronic device 110 or processing units 161 of the electronic device 150), can be configured to operate as varying processing stages during different time periods of an active time period. An active time period may occur when a processor is powered in an active mode. An active mode includes when the device is powered on to process data received from a sensor, when the device is not powered off, or when the device is not in a low-power state. As depicted, active time periods do not occur during inactive time periods. Inactive time periods may include when the device 300 is powered off or when the device 300 is in the low-power state (e.g., a sleep mode). The timing diagram of FIG. 3 depicts the device operating over a timeline 305 including multiple time periods: some active time periods during an active mode and some inactive time periods.

During the timeline 305, which may be a timeline for a discontinuous reception (DRX) or discontinuous transmission (DTX) mode of operation, the device 300 may be configured to operate in varying processing stages during the active time period (e.g., specific time periods of the active time period). During the active time period, electronic device 300 may be configured to include a source data processing stage 320. The source data processing stage 320 may receive data from the sensor 317 and generate output data to be stored in the memory 340. The source data processing stage 320 may include pre-processing for the data received from the sensors. Such pre-processing may include noise reduction, sampling-converting, filtering, compression or coding, feature extraction or feature transformation. Source data processors may include video encoders/decoders, image encoders/decoders, audio encoders/decoders, other sensor type encoders/decoders, and the like.

As described herein, the electronic device 300 may execute control instructions that implement a configuration for the processing units, for example, a configuration A, during the active time period. In accordance with that configuration, the processing units of the electronic device 300 implement the source data processing stage 320 to receive the data from the sensor 317 and generate output data to be stored in the memory 340. In the context of the example of FIG. 2, the data received in the processing units of the electronic device 300 may be input data 210a-c (e.g. X (i,j)). The source data processing stage 320 mixes the input data 210a-c with weight data specific to the source data processing stage 320 to generate the output data 220a-c (e.g. B (u,v)). The specific weight data may be stored in the memory 340. Coefficients associated with the source data processing stage 320 may be utilized such that the output data is an approximation of input data being processed according to such a source data processing stage being implemented in a signal processor, such as an FPGA. In the example of FIG. 3, the output data from the source data processing stage 320 may be referred to as first intermediate output data.

Along the timeline 305, the device 300 may be further configured to operate in another processing stage during the active time period. During active time period, the electronic device 300 may be configured to include a baseband processing stage 325. The baseband processing stage 325 may include various baseband signal processing techniques, including but not limited to: scrambling, error-correction coding, inner coding, interleaving, frame adaptation, modulation, multi-user access coding, filter processing, inverse Fourier transforms, and/or guard interval addition. Coding may include Turbo coding, polar coding, or low-density parity-check (LDPC) coding. Modulation may include sparse code multiple access (SCMA), orthogonal frequency division multiple access (OFDMA), multi-user shared access (MUSA), non-orthogonal multiple access (NOMA), and/or polarization division multiple access (PDMA). Multi-user access coding may include Filtered-Orthogonal Frequency Division Multiplexing (F-OFDM), Filter-Bank Frequency Division Multiplexing (FB-OFDM), Spectrally Efficient Frequency Division Multiplexing (SEFDM), and/or Filter Bank Multicarrier (FBMC).

For Massive MIMO implementations, additional baseband processing may include pre-coding estimation and various other functionalities associated with Massive MIMO. Filter processing may include various types of digital filters, such as a finite impulse response (FIR) filter, a poly-phase network (PPN) filter, and/or QQ⁻¹ filter, which may refer to a filter that adjusts for compression and decompression of data.

As described herein, the electronic device 300 may execute control instructions that implement a configuration for the processing units, for example, configuration B for the active time period (e.g., during a time period that may occur after implementing configuration A). In accordance with that configuration B, the processing units of the electronic device 300 implement the baseband processing stage 325 to receive input data (e.g., the intermediate output data) from the source data processing stage 320 and generate second intermediate output data. The processing units implementing configuration B can include some or all of the processing units that had implemented configuration A. Accordingly, the electronic device 300 may efficiently utilize hardware resources (e.g., processing units) in each time period, thereby avoiding the disadvantages of other processing systems/techniques that can include additional hardware or specially-designed hardware for the signal processing implemented in the source data processing stage 320 and baseband processing stage 325. The electronic device 300 may implement the source data processing stage 320 and baseband processing stage 325 with a lower power consumption (e.g., only operating in active time period) and utilizes less die space on a silicon chip than conventional signal processing systems and techniques that can include additional hardware or specially-designed hardware.

For the baseband processing stage 325, the input data may be the output data generated by the source data processing stage 320. In the context of the example of FIG. 2, the data input to the processing units implementing the baseband processing stage 325 may correspond to or include input data 210a-c (e.g. X (i,j)). The baseband processing stage 325 mixes the input data 210a-c with weight data specific to the baseband processing stage 325 to generate the output data 220a-c (e.g. B (u,v)) . . . . Coefficients associated with the baseband processing stage 325 may be utilized such that the output data is an approximation of input data being processed according to such a baseband processing stage being implemented in a signal processor, such as an FPGA. In the example of FIG. 3, the output data from the baseband processing stage 325 may be referred to as second intermediate output data.

Along the timeline 305, the device 300 may be further configured to operate in additional processing stages during the active time period. During the active time period, the electronic device 300 may be configured to include a digital front-end processing stage 330 and a radio frequency (RF) processing stage 335. The digital front-end processing stage 330 may include estimated processing of a wireless transmitter or a wireless receiver. The digital front-end processing stage 330 may include various functionalities for operating as a digital front-end transmitter or receiver, such as: an analog-to-digital conversion (ADC) processing, digital-to-analog (DAC) conversion processing, digital up conversion (DUC), digital down conversion (DDC), direct digital synthesizer (DDS) processing, DDC with DC offset compensation, digital pre-distortion (DPD), peak-to-average power ratio (PAPR) determinations, crest factor reduction (CFR) determinations, pulse-shaping, image rejection, delay/gain/imbalance compensation, noise-shaping, numerical controlled oscillator (NCO), and/or self-interference cancellation (SIC).

As described herein, the electronic device 300 may execute control instructions that implement a configuration for the processing units, for example, configuration C for the active time period (e.g., after implementing the configuration B). In accordance with that configuration C, the processing units of the electronic device 300 implement the digital front-end processing stage 330 to receive input data from the baseband processing stage 325 and generate output data that is outputted to the RF processing stage 335. The processing units implementing configuration C can include some or all of the processing units that had implemented configuration A and/or configuration B. The electronic device 300 may implement the digital front-end processing stage 330 and the RF processing stage 335 with a lower power consumption (e.g., only operating in active time period) and utilizes less die space on a silicon chip than conventional signal processing systems and techniques that can include additional hardware or specially-designed hardware.

For digital front-end processing stage 330, the input data may be the output data generated by the baseband processing stage 325. In the context of the example of FIG. 2, the data retrieved from the baseband processing stage 325 input to the processing units implementing the digital front-end processing stage 330 may correspond to or include input data 210a-c (e.g. X (i,j)). The digital front-end processing stage 330 mixes the input data 210a-c with weight data specific to the digital front-end processing stage 330 to generate the output data 220a-c (e.g. B (u,v)). Coefficients associated with the digital front-end processing stage may be utilized such that the output data is an approximation of input data being processed according to such a digital front-end processing stage being implemented in a signal processor, such as an FPGA.

Further to configuration C, the processing units of the electronic device 300 implement the RF processing stage 335 to receive input data from the digital front-end processing stage 330 and generate output data that is sent to the antenna 361 for an RF transmission. In the example of FIG. 3, the output data from the digital front-end processing stage 330 and the RF processing stage 335 may be referred to as third intermediate output data. The RF processing stage 335 may include further processing of the input data as a signal in an analog domain to configure such a signal for input to a power amplifier (PA) and antenna 361. A signal may be output from the RF processing stage 335 to be transmitted as an analog RF transmission via the antenna 361. The signal to be transmitted as an analog RF transmission via the antenna 361 may include the output data referred to as the final output data. Such a transmission may occur during an inactive time period of the electronic device 300. In some implementations, the signal may initially be sent to a PA (not depicted) before proceeding for transmission to the antenna 361.

In some examples, the electronic device 300 may contemporaneously, semi-contemporaneously, or non-contemporaneously, process the input data from sensor 317 via the source data processing stage 320, the baseband processing stage 325, the digital front-end processing stage 330, the radio frequency processing stage 335, or a combination thereof, using the integrated sensing and processing neural network 301. One or more units and processes of the processing unit 205 of FIG. 2 may be configured to implement the integrated sensing and processing neural network 301, in some examples. The electronic device 300 may process input data from sensor 317 using each stage contemporaneously, or using some stages contemporaneously while using other stages at different times, for processing. In this way, source data processing stage 320 may be able to be combined with communication processing stages (e.g., baseband processing stage 325, digital front-end processing stage 330, radio frequency processing stage 335) using a single neural network.

The electronic device 300 may process one or more stages using one or more configurations (e.g., configuration A, configuration B, or some other configuration). For example, the electronic device 300 may process data using source data processing stage 320 and baseband processing stage 325 in one configuration, and other stages in another configuration. The configurations may be controlled by changing weights or weights provided to the integrated sensing and processing neural network 301. Each stage may be processed using a different configuration, or each stage may be processed using the same configuration, or a portion of the stages may use one configuration, while other stages use another configuration. Such different configurations may still use the same neural network, but the neural network may be configured differently.

By integrating the source data processing stage 320 with the communication processing stages (e.g., baseband processing stage 325, digital front-end processing stage 330, radio frequency processing stage 335), a number of processor chips of the electronic device 300 may be reduced. In addition, using the integrated sensing and processing neural network 301 to implement the source data processing stage 320 may facilitate a more versatile system that allows configuration of multiple different source data processor types simply by changing the configuration of the neural network, as opposed to having a dedicated source data processor for each source data type. Similarly, integrating the source data processing stage with the communication processing stages allows greater configurability across different source data types and different communication protocols.

Additionally or alternatively, the electronic device 300 may be able to support multiple different types of source data processors (e.g., audio, video, image, temperature, pressure, acceleration, and the like) by changing the configuration of the neural network, rather than having a dedicated source data processor for each source data type.

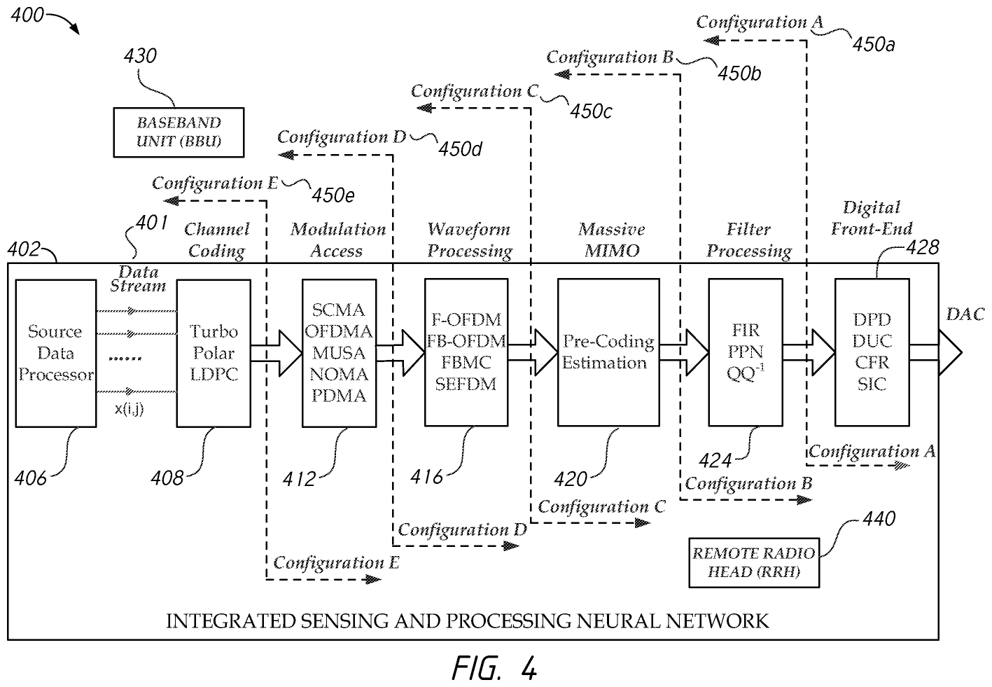

FIG. 4 is a schematic illustration of a computing system 400 arranged in accordance with examples described herein. The computing system 400 includes a baseband unit (BBU) 430 and a remote radio head (RRH) 440. The computing system may be implemented in electronic device 110, 150, or both. While not depicted as coupled in FIG. 4, the BBU 430 and the RRH 440 may be coupled via a fronthaul link. The computing system 400 may be configured to implement various configuration modes 450a-450e, with each configuration mode allocating a wireless processing stage to either the BBU 430 or the RRH 440, as indicated by the directional dotted arrows pointing towards either the BBU 430 or the RRH 440. In some cases, the configuration modes 450a-450e may correspond to or include the configuration modes of FIG. 3. The computing system 400 receives input data x (i,j) 401 from the source data processor 406 and performs wireless processing stages on the input data. The BBU 430 and the RRH 440 operate in conjunction upon the input data x (i,j) 401 to perform various wireless processing stages, with the operation of the wireless processing stage dependent on the configuration mode 450a-c.

The wireless processing stages of FIG. 4 include channel coding 408, modulation access 412, waveform processing 416, massive MIMO 420, filter processing 424, and digital front-end 428. A communication processing stage of FIG. 4 may include source data processor circuit 406 configured to receive and processor source or sensor data. Channel coding 408 may include Turbo coding, polar coding, or low-density parity-check (LDPC) coding. It can be appreciated that channel coding 408 can include various types of channel coding. Modulation access 412 may include sparse code multiple access (SCMA), orthogonal frequency division multiple access (OFDMA), multi-user shared access (MUSA), non-orthogonal multiple access (NOMA), and/or polarization division multiple access (PDMA). Waveform processing 416 may include Filtered-Orthogonal Frequency Division Multiplexing (F-OFDM), Filter-Bank Frequency Division Multiplexing (FB-OFDM), Spectrally Efficient Frequency Division Multiplexing (SEFDM), and/or Filter Bank Multicarrier (FBMC). It can be appreciated that modulation access 412 can include various types of modulation access. The Massive MIMO 420 may include pre-coding estimation and various other functionalities associated with Massive MIMO. Filter processing 424 may include various types of digital filters, such as a finite impulse response (FIR) filter, a poly-phase network (PPN) filter, and/or QQ⁻¹ filter, which may refer to a filter that adjusts for compression and decompression of data. The digital front-end 428 may include baseband processing of a wireless transmitter or a wireless receiver. Such a digital front-end may include various functionalities for operating as a digital front-end transmitter or receiver, such as: an analog-to-digital conversion (ADC) processing, digital-to-analog (DAC) conversion processing, digital up conversion (DUC), digital down conversion (DDC), direct digital synthesizer (DDS) processing, DDC with DC offset compensation, digital pre-distortion (DPD), peak-to-average power ratio (PAPR) determinations, crest factor reduction (CFR) determinations, pulse-shaping, image rejection, delay/gain/imbalance compensation, noise-shaping, numerical controlled oscillator (NCO), and/or self-interference cancellation (SIC).

It can be appreciated that the RRH 440 may operate as a wireless transmitter or a wireless receiver (or both as multiplexing wireless transceivers). While depicted in FIG. 4 with the RRH 440 operating as a wireless transmitter (by receiving a processed input data stream x (i,j) 401), it can be appreciated that the RRH 440 may operate as a wireless receiver that receives a transmitted wireless signal and processes that signal, according to wireless processing stages allocated to the RRH 440. The data flow may flow the opposite way to the depiction of FIG. 4, with the functionalities of the various wireless processing stages inverted. For example, in a configuration mode E 450c, the BBU 430 may receive an intermediate processing result from the RRH 440 and decode that intermediate processing result at the wireless processing stage associated with channel coding 408.

Upon determination of a configuration mode or upon receiving a configuration mode selection, the computing system 400 may allocate the wireless processing stages 408, 412, 416, 420, 424, and 428 to either the BBU 430 or the RRH 440. The configuration mode A 450a configures the RRH 440 to perform the one wireless processing stage, the digital front-end 428. In configuration mode A 450a, the other wireless processing stages, channel coding 408, modulation access 412, waveform processing 416, massive MIMO 420, and filter processing 424, are performed by the BBU 430. The computing system 400 may receive an additional configuration mode selection or determine a different configuration mode, based at least on processing times of the BBU 430 and the RRH 440. When a different configuration mode is specified, the BBU 430 and the RRH 440 may allocate processing unit(s) of each accordingly to accommodate the different configuration mode. Each configuration mode 450a-450c may be associated with a different set of weights for both the BBU 430 and the RRH 440 that is to be mixed with either the input data x (i,j) 401 or an intermediate processing result. Coefficients may be also associated with specific wireless protocols, such as 5G wireless protocols, such that the BBU 430 and the RRH 440 may be processed according to different wireless protocols. The intermediate processing results may be any processing result received by the other entity (e.g., the RRH 440 or the BBU 430), upon completion of processing by the initial entity (e.g., the BBU 430 or the RRH 440, respectively). As depicted in FIG. 4, various configuration modes 450a-450e are possible.

In some examples, the computing system 400 may contemporaneously, semi-contemporaneously, or non-contemporaneously, process data via the source data processor circuit 406, the channel coding 408, modulation access 412, waveform processing 416, massive MIMO 420, filter processing 424, digital front-end 428, or a combination thereof, using the integrated sensing and processing neural network 402. The computing system 400 may process data using each stage contemporancously, or using some stages contemporaneously while using other stages at different times, for processing. In this way, source data processor circuit 406 may be able to be combined with communication processing stages (e.g., channel coding 408, modulation access 412, waveform processing 416, massive MIMO 420, filter processing 424, digital front-end 428) using a single neural network. The integrated sensing and processing neural network 402 may utilize one or more units and processes from the processing unit 205 in FIG. 2. By integrating the processing of the source data processor circuit 406 with the communication processing stages (e.g., channel coding 408, modulation access 412, waveform processing 416, massive MIMO 420, filter processing 424, digital front-end 428), a number of processor chips of the computing system 400 may be reduced. In addition, using the integrated sensing and processing neural network 402 to implement the source data processor circuit 406 may facilitate a more versatile system that allows configuration of multiple different source data processor types simply by changing the configuration of the neural network, as opposed to having a dedicated source data processor for each source data type. Similarly, integrating the source data processing stage with the communication processing stages allows greater configurability across different source data types and different communication protocols.

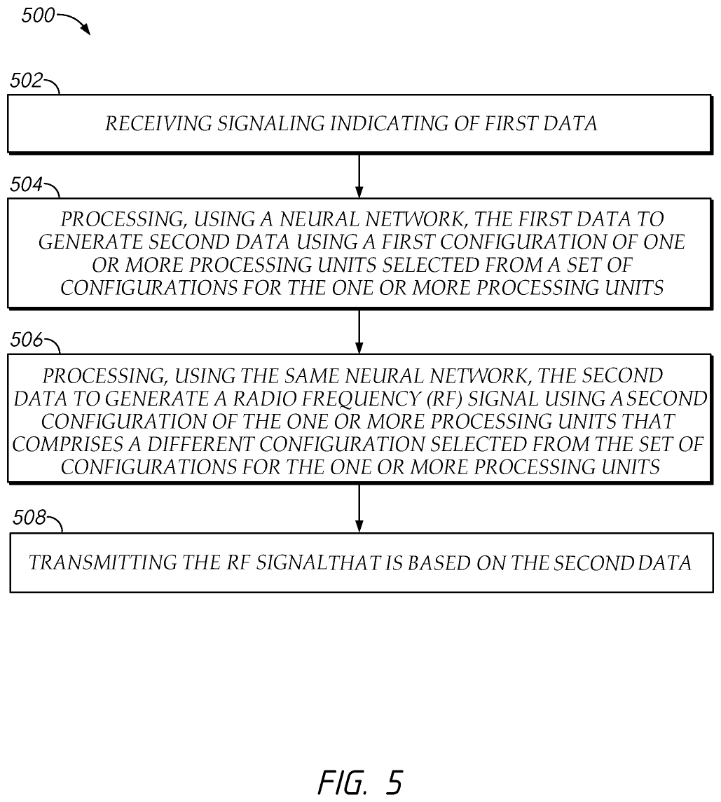

FIG. 5 is a flowchart of a method 500 in accordance with examples described herein. Example method 500 may be implemented using, for example, computing system 100 in FIG. 1, computing system 200 in FIG. 2, electronic device 300 in FIG. 3, computing system 400 in FIG. 4, or any system or combination of the systems depicted in FIGS. 1-4 described herein. In some examples, the blocks in example method 500 may be performed by a computing system such as a computing system 300 of FIG. 3 implementing processing units in the hardware platforms (e.g., a reconfigurable fabric) therein as a processing unit 205 of FIG. 2. The operations described in blocks 504-508 may also be stored as control instructions in a computer-readable medium at an electronic device 110, 150, or 300, such as control instructions 113, control instructions 163, executable instructions 115, or memory 340. In some examples, various hardware platforms may implement the method 500, such as an ASIC, a DSP implemented as part of a FPGA, or a system-on-chip. In some examples, the method 500 may be implemented in a non-transitory computer readable medium including instructions executable to cause a wireless communication device to perform one or more of the operations of the method 500.

The method 500 may include receiving signaling indicative of first data, at 502. In some examples, the method 500 may include receiving the signaling indicative of the first data from a sensor detecting an environmental characteristic.

The method 500 may include processing, using a neural network, the first data to generate second data using a first configuration of one or more processing units selected from a set of configurations for the one or more processing units, at 504. In some examples, the first configuration includes a source data processor stage, wherein the second configuration includes a baseband processor stage.

The method 500 may include processing, using the same neural network, the second data to generate a radio frequency (RF) signal using a second configuration of the one or more processing units that includes a different configuration selected from the set of configurations for the one or more processing units, at 506. In some examples, the second configuration includes a digital front-end processing stage, a radio frequency processor stage, or a combination thereof. In some examples, the processing using the different configurations is performed using one processing unit.

The method 500 may include transmitting the RF signal that is based at least in part on the third data, at 506 and 508. In some examples, transmitting the RF signal includes transmitting the RF signal at a frequency band corresponding to at least one of 1 MHz, 5 MHz, 10 MHz, 20 MHz, 700 MHz, 2.4 GHz, or 24 GHz. In some examples, a time period including the receiving, processing, and transmitting, includes an active time period of a discontinuous reception (DRX) or discontinuous transmission (DTX) cycle. In some examples, the DRX or DTX cycle includes an inactive time period designated for powering down one or more components of a device operation according to the DRX or DTX cycle.

The steps 502, 504, 506, and 508 of the method 500 are for illustration purposes. In some examples, the steps 502, 504, 506, and 508 may be performed in a different order. In some other examples, various steps 502, 504, 506, and 508 may be eliminated. In still other examples, various steps 502, 504, 506, and 508 may be divided into additional steps, supplemented with other steps, or combined together into fewer steps. Other variations of these specific steps are contemplated, including changes in the order of the steps, changes in the content of the steps being split or combined into other steps, etc.

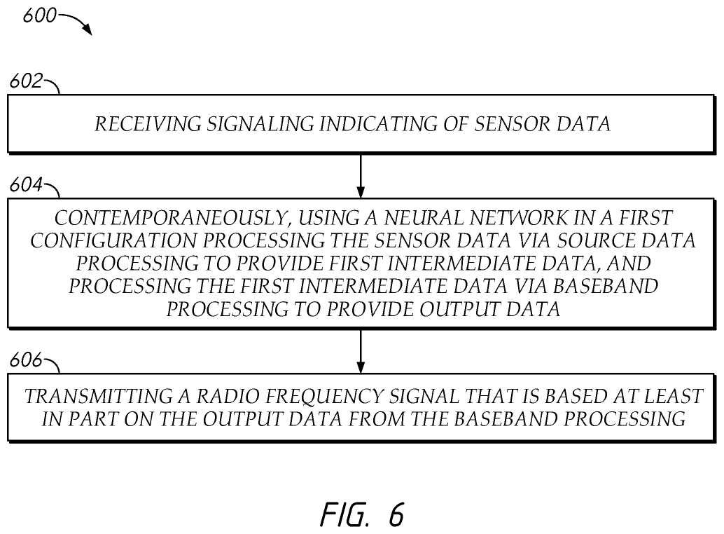

FIG. 6 is a flowchart of a method 600 in accordance with examples described herein. Example method 600 may be implemented using, for example, computing system 100 in FIG. 1, computing system 200 in FIG. 2, electronic device 300 in FIG. 3, computing system 400 in FIG. 4, or any system or combination of the systems depicted in FIGS. 1-4 described herein. In some examples, the blocks in example method 600 may be performed by a computing system such as a computing system 300 of FIG. 3 implementing processing units in the hardware platforms (e.g., a reconfigurable fabric) therein as a processing unit 205 of FIG. 2. The operations described in blocks 604-606 may also be stored as control instructions in a computer-readable medium at an electronic device 110, 150, or 300, such as control instructions 113, control instructions 163, executable instructions 115, or memory 340. In some examples, various hardware platforms may implement the method 600, such as an ASIC, a DSP implemented as part of a FPGA, or a system-on-chip. In some examples, the method 600 may be implemented in a non-transitory computer readable medium including instructions executable to cause a wireless communication device to perform one or more of the operations of the method 600.

The method 600 may include receiving signaling indicative of sensor data, at 602. In some examples, a first type of sensor data includes audio, video, image, temperature, pressure, or acceleration data.

The method 600 may include contemporaneously, using a neural network in a first configuration processing the sensor data via source data processing to provide first intermediate data, and processing the first intermediate data via baseband processing to provide output data, at 604. In some examples, the sensor data is a first type, and the method 600 may include switching configurations of the neural network to a second configuration capable of supporting a second type of the sensor data, and processing the sensor data via source data processing using the second configuration. In some examples, the second type of sensor data includes another of the audio, video, image, temperature, pressure, or acceleration data.

The method 600 may include transmitting a radio frequency signal that is based at least in part on the output data from the baseband processing, at 606. In some examples, a time period including the receiving, processing, and transmitting, includes an active time period of a discontinuous reception (DRX) or discontinuous transmission (DTX) cycle. In some examples, the DRX or DTX cycle includes an inactive time period designated for powering down one or more components of a device operation according to the DRX or DTX cycle.

The steps 602, 604, and 606 of the method 600 are for illustration purposed. In some examples, the steps 602, 604, and 606 may be performed in a different order. In some other examples, various steps 602, 604, and 606 may be eliminated. In still other examples, various steps 602, 604, and 606 may be divided into additional steps, supplemented with other steps, or combined together into fewer steps. Other variations of these specific steps 602, 604, and 606 are contemplated, including changes in the order of the steps, changes in the content of the steps being split or combined into other steps, etc.

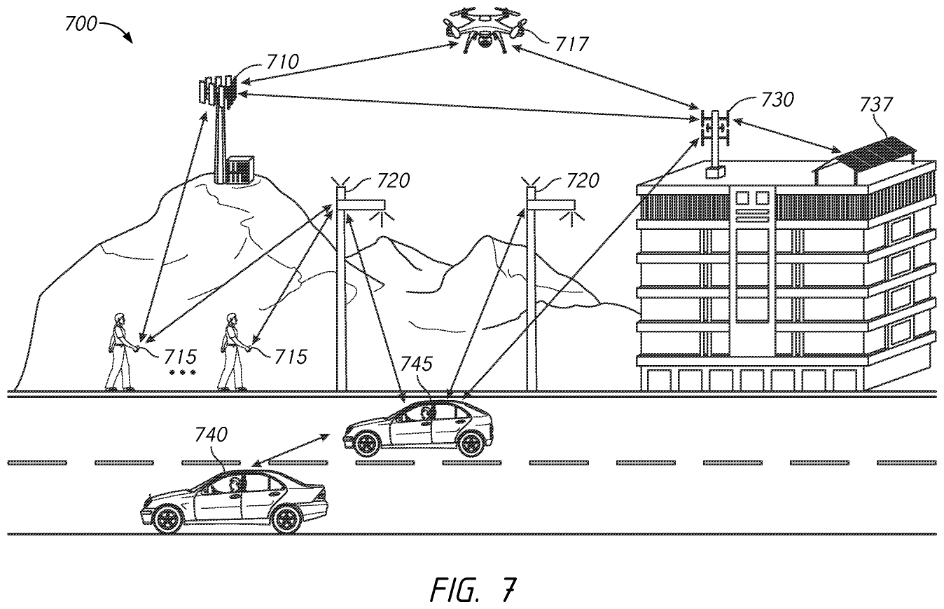

FIG. 7 illustrates an example of a wireless communications system 700 in accordance with aspects of the present disclosure. The wireless communications system 700 includes a base station 710, a mobile device 715, a drone 717, a small cell 730, and vehicles 740, 745. The base station 710 and small cell 730 may be connected to a network that provides access to the Internet and traditional communication links. The system 700 may facilitate a wide-range of wireless communications connections in a 5G wireless system that may include various frequency bands, including but not limited to: a sub-6 GHz band (e.g., 700 MHz communication frequency), mid-range communication bands (e.g., 2.4 GHZ), and mmWave bands (e.g., 24 GHZ).

Additionally or alternatively, the wireless communications connections may support various modulation schemes, including but not limited to: filter bank multi-carrier (FBMC), the generalized frequency division multiplexing (GFDM), universal filtered multi-carrier (UFMC) transmission, bi-orthogonal frequency division multiplexing (BFDM), sparse code multiple access (SCMA), non-orthogonal multiple access (NOMA), multi-user shared access (MUSA), and faster-than-Nyquist (FTN) signaling with time-frequency packing. Such frequency bands and modulation techniques may be a part of a standards framework, such as Long Term Evolution (LTE) or other technical specification published by an organization like 3GPP or IEEE, which may include various specifications for subcarrier frequency ranges, a number of subcarriers, uplink/downlink transmission speeds, TDD/FDD, and/or other aspects of wireless communication protocols.

The system 700 may depict aspects of a radio access network (RAN), and system 700 may be in communication with or include a core network (not shown). The core network may include one or more serving gateways, mobility management entities, home subscriber servers, and packet data gateways. The core network may facilitate user and control plane links to mobile devices via the RAN, and it may be an interface to an external network (e.g., the Internet). Base stations 710, communication devices 720, and small cells 730 may be coupled with the core network or with one another, or both, via wired or wireless backhaul links (e.g., S1 interface, X2 interface, etc.).

The system 700 may provide communication links connected to devices or “things,” such as sensor devices, e.g., solar cells 737, to provide an Internet of Things (“IoT”) framework. Connected things within the IoT may operate within frequency bands licensed to and controlled by cellular network service providers, or such devices or things may. Such frequency bands and operation may be referred to as narrowband IoT (NB-IoT) because the frequency bands allocated for IoT operation may be small or narrow relative to the overall system bandwidth. Frequency bands allocated for NB-IoT may have bandwidths of 50, 100, or 200 KHz, for example.

Additionally or alternatively, the IoT may include devices or things operating at different frequencies than traditional cellular technology to facilitate use of the wireless spectrum. For example, an IoT framework may allow multiple devices in system 700 to operate at a sub-6 GHz band or other industrial, scientific, and medical (ISM) radio bands where devices may operate on a shared spectrum for unlicensed uses. The sub-6 GHz band may also be characterized as and may also be characterized as an NB-IoT band. For example, in operating at low frequency ranges, devices providing sensor data for “things,” such as solar cells 737, may utilize less energy, resulting in power-efficiency and may utilize less complex signaling frameworks, such that devices may transmit asynchronously on that sub-6 GHz band. The sub-6 GHz band may support a wide variety of use cases, including the communication of sensor data from various sensors devices. Examples of sensor devices include sensors for detecting energy, heat, light, vibration, biological signals (e.g., pulse, EEG, EKG, heart rate, respiratory rate, blood pressure), distance, speed, acceleration, or combinations thereof. Sensor devices may be deployed on buildings, individuals, and/or in other locations in the environment. The sensor devices may communicate with one another and with computing systems which may aggregate and/or analyze the data provided from one or multiple sensor devices in the environment. Such data may be used to indicate an environmental characteristic of the sensor.

In such a 5G framework, devices may perform functionalities performed by base stations in other mobile networks (e.g., UMTS or LTE), such as forming a connection or managing mobility operations between nodes (e.g., handoff or reselection). For example, mobile device 715 may receive sensor data from the user utilizing the mobile device 715, such as blood pressure data, and may transmit that sensor data on a narrowband IoT frequency band to base station 710. In such an example, some parameters for the determination by the mobile device 715 may include availability of licensed spectrum, availability of unlicensed spectrum, and/or time-sensitive nature of sensor data. Continuing in the example, mobile device 715 may transmit the blood pressure data because a narrowband IoT band is available and can transmit the sensor data quickly, identifying a time-sensitive component to the blood pressure (e.g., if the blood pressure measurement is dangerously high or low, such as systolic blood pressure is three standard deviations from norm).

Additionally or alternatively, mobile device 715 may form device-to-device (D2D) connections with other mobile devices or other elements of the system 700. For example, the mobile device 715 may form RFID, WiFi, MultiFire, Bluetooth, or Zigbee connections with other devices, including communication device 720 or vehicle 745. In some examples, D2D connections may be made using licensed spectrum bands, and such connections may be managed by a cellular network or service provider. Accordingly, while the above example was described in the context of narrowband IoT, it can be appreciated that other device-to-device connections may be utilized by mobile device 715 to provide information (e.g., sensor data) collected on different frequency bands than a frequency band determined by mobile device 715 for transmission of that information.

Moreover, some communication devices may facilitate ad-hoc networks, for example, a network being formed with communication devices 720 attached to stationary objects) and the vehicles 740, 745, without a traditional connection to a base station 710 and/or a core network necessarily being formed. Other stationary objects may be used to support communication devices 720, such as, but not limited to, trees, plants, posts, buildings, blimps, dirigibles, balloons, street signs, mailboxes, or combinations thereof. In such a system 700, communication devices 720 and small cell 730 (e.g., a small cell, femtocell, WLAN access point, cellular hotspot, etc.) may be mounted upon or adhered to another structure, such as lampposts and buildings to facilitate the formation of ad-hoc networks and other IoT-based networks. Such networks may operate at different frequency bands than existing technologies, such as mobile device 715 communicating with base station 710 on a cellular communication band.

The communication devices 720 may form wireless networks, operating in either a hierarchal or ad-hoc network fashion, depending, in part, on the connection to another element of the system 700. For example, the communication devices 720 may utilize a 700 MHz communication frequency to form a connection with the mobile device 715 in an unlicensed spectrum, while utilizing a licensed spectrum communication frequency to form another connection with the vehicle 745. Communication devices 720 may communicate with vehicle 745 on a licensed spectrum to provide direct access for time-sensitive data, for example, data for an autonomous driving capability of the vehicle 745 on a 5.9 GHz band of Dedicated Short Range Communications (DSRC).

Vehicles 740 and 745 may form an ad-hoc network at a different frequency band than the connection between the communication device 720 and the vehicle 745. For example, for a high bandwidth connection to provide time-sensitive data between vehicles 740, 745, a 24 GHZ mmWave band may be utilized for transmissions of data between vehicles 740, 745. For example, vehicles 740, 745 may share real-time directional and navigation data with each other over the connection while the vehicles 740, 745 pass each other across a narrow intersection line. Each vehicle 740, 745 may be tracking the intersection line and providing image data to an image processing algorithm to facilitate autonomous navigation of each vehicle while each travels along the intersection line. In some examples, this real-time data may also be substantially simultaneously shared over an exclusive, licensed spectrum connection between the communication device 720 and the vehicle 745, for example, for processing of image data received at both vehicle 745 and vehicle 740, as transmitted by the vehicle 740 to vehicle 745 over the 24 GHz mm Wave band. While shown as automobiles in FIG. 7, other vehicles may be used including, but not limited to, aircraft, spacecraft, balloons, blimps, dirigibles, trains, submarines, boats, ferries, cruise ships, helicopters, motorcycles, bicycles, drones, or combinations thereof.

While described in the context of a 24 GHz mmWave band, it can be appreciated that connections may be formed in the system 700 in other mmWave bands or other frequency bands, such as 28 GHz, 37 GHZ, 38 GHZ, 39 GHz, which may be licensed or unlicensed bands. In some cases, vehicles 740, 745 may share the frequency band that they are communicating on with other vehicles in a different network. For example, a fleet of vehicles may pass vehicle 740 and, temporarily, share the 24 GHz mm Wave band to form connections among that fleet, in addition to the 24 GHz mmWave connection between vehicles 740, 745. As another example, communication device 720 may substantially simultaneously maintain a 700 MHz connection with the mobile device 715 operated by a user (e.g., a pedestrian walking along the street) to provide information regarding a location of the user to the vehicle 745 over the 5.9 GHz band. In providing such information, communication device 720 may leverage antenna diversity schemes as part of a massive MIMO framework to facilitate time-sensitive, separate connections with both the mobile device 715 and the vehicle 745. A massive MIMO framework may involve a transmitting and/or receiving devices with a large number of antennas (e.g., 12, 20, 64, 128, etc.), which may facilitate precise beamforming or spatial diversity unattainable with devices operating with fewer antennas according to legacy protocols (e.g., WiFi or LTE).

The base station 710 and small cell 730 may wirelessly communicate with devices in the system 700 or other communication-capable devices in the system 700 having at the least a sensor wireless network, such as solar cells 737 that may operate on an active/sleep cycle, and/or one or more other sensor devices. The base station 710 may provide wireless communications coverage for devices that enter its coverage area, such as the mobile device 715 and the drone 717. The small cell 730 may provide wireless communications coverage for devices that enter its coverage area, such as near the building that the small cell 730 is mounted upon, such as vehicle 745 and drone 717.

Generally, the small cell 730 may be referred to as a small cell and provide coverage for a local geographic region, for example, coverage of 200 meters or less in some examples. This may be contrasted with a macrocell, which may provide coverage over a wide or large area on the order of several square miles or kilometers. In some examples, a small cell 730 may be deployed (e.g., mounted on a building) within some coverage areas of a base station 710 (e.g., a macrocell) where wireless communications traffic may be dense according to a traffic analysis of that coverage area. For example, a small cell 730 may be deployed on the building in FIG. 7 in the coverage area of the base station 710 if the base station 710 generally receives and/or transmits a higher amount of wireless communication transmissions than other coverage areas of that base station 710. A base station 710 may be deployed in a geographic area to provide wireless coverage for portions of that geographic area. As wireless communications traffic becomes denser, additional base stations 710 may be deployed in certain areas, which may alter the coverage area of an existing base station 710, or other support stations may be deployed, such as a small cell 730. Small cell 730 may be a femtocell, which may provide coverage for an area smaller than a small cell (e.g., 100 meters or less in some examples (e.g., one story of a building)).

While base station 710 and small cell 730 may provide communication coverage for a portion of the geographical area surrounding their respective areas, both may change aspects of their coverage to facilitate faster wireless connections for certain devices. For example, the small cell 730 may primarily provide coverage for devices surrounding or in the building upon which the small cell 730 is mounted. However, the small cell 730 may also detect that a device has entered its coverage area and adjust its coverage area to facilitate a faster connection to that device.

For example, a small cell 730 may support a massive MIMO connection with the drone 717, which may also be referred to as an unmanned aerial vehicle (UAV), and, when the mobile device 715 enters it coverage area, the small cell 730 adjusts some antennas to point directionally in a direction of the vehicle 745, rather than the drone 717, to facilitate a massive MIMO connection with the vehicle, in addition to the drone 717. In adjusting some of the antennas, the small cell 730 may not support as fast as a connection to the drone 717, as it had before the adjustment. However, the drone 717 may also request a connection with another device (e.g., base station 710) in its coverage area that may facilitate a similar connection as described with reference to the small cell 730, or a different (e.g., faster, more reliable) connection with the base station 710. Accordingly, the small cell 730 may enhance existing communication links in providing additional connections to devices that may utilize or demand such links. For example, the small cell 730 may include a massive MIMO system that directionally augments a link to vehicle 745, with antennas of the small cell directed to the vehicle 745 for a specific time period, rather than facilitating other connections (e.g., the small cell 730 connections to the base station 710, drone 717, or solar cells 737). In some examples, drone 717 may serve as a movable or aerial base station.

The wireless communications system 700 may include devices such as base station 710, communication device 720, and small cell 730 that may support several connections to devices in the system 700. Such devices may operate in a hierarchal mode or an ad-hoc mode with other devices in the network of system 700. While described in the context of a base station 710, communication device 720, and small cell 730, it can be appreciated that other devices that can support several connections with devices in the network may be included in system 700, including but not limited to: macrocells, femtocells, routers, satellites, and RFID detectors.

In various examples, the elements of wireless communication system 700, such as the drone 717 and the solar cells 737, may be implemented utilizing the systems, apparatuses, and methods described herein. For example, the computing system 100 implementing the electronic device 110 as the electronic device 300, may be implemented in any of the elements of communication system 700. For example, the solar cells 737 may be implemented as the electronic device 300. In the example, the drone 717 and the solar cells 737 may be implemented as the electronic device 110 and the electronic device 150 communicating over narrowband IoT channels. The drone 717, being implemented as the electronic device 110, may include a sensor to detect various aerodynamic properties of the drone 717 traveling through the air space. For example, the drone 717 may include sensors to detect wind direction, airspeed, or any other sensor generally included vehicles with acrodynamic properties. The drone 717 may provide the sensor data to processing units 111 that are configured to operate for an active time period and process the sensor data over a sequence of configurations partly based on a clock signal (e.g., GMT time) that the drone 717 receives from the base station 710. The drone 717 transmits an RF signal via the antenna 101 to the base station 710 with the sensor data that was processed by the processing units 111 implementing various processing stages, as described herein. Accordingly, the drone 717 may utilize less die space on a silicon chip than conventional signal processing systems and techniques that can include additional hardware or specially-designed hardware, thereby allowing the drone 717 to be of smaller size compared to drones having such conventional signal processing systems and techniques.

In the example, the solar cells 737, being implemented as the electronic device 150, may include a photoelectric sensor to detect light on the solar cells 737. The solar cells 737 may provide that sensor data to processing units 161 that are configured to operate for an active time period and process the sensor data over a sequence of configurations. For example, during the source data processing stage 320, the processing units 161 may implement the source data processing stage 320 to sample and convert the electrical representations of the sensor data into a sampled digital signal, including coding that digital signal. After further processing of that digital signal at the baseband processing stage 325, the digital front-end processing stage 330, and the RF processing stage 335, the solar cells 737 transmit an RF signal via the antennas 151, 157 to the small cell 730 that is configured to receive a MIMO signal.

Additionally or alternatively, while described in the examples above in the context of the drone 717 and the solar cells 737, the elements of communication system 700 may be implemented as part of any of the computing systems disclosed herein, including: computing system 100 in FIG. 1, computing system 200 in FIG. 2, electronic device 300 in FIG. 3, computing system 400 in FIG. 4, or any system or combination of the systems depicted in FIGS. 1-4 described herein.

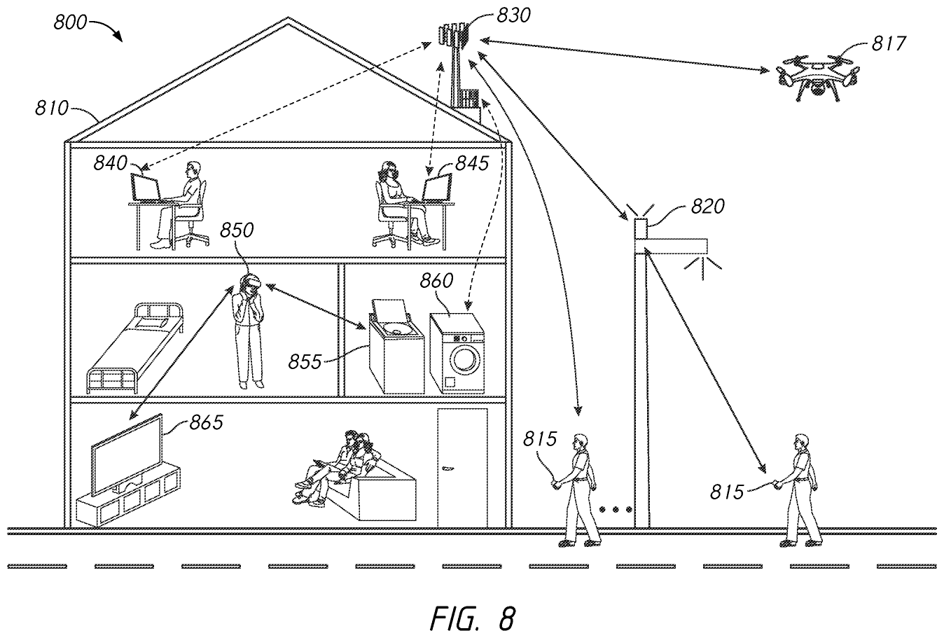

FIG. 8 illustrates an example of a wireless communications system 800 in accordance with aspects of the present disclosure. The wireless communications system 800 includes a mobile device 815, a drone 817, a communication device 820, and a small cell 830. A building 810 also includes devices of the wireless communications system 800 that may be configured to communicate with other elements in the building 810 or the small cell 830. The building 810 includes networked workstations 840, 845, virtual reality device 850, IoT devices 855, 860, and networked entertainment device 865. In the depicted wireless communications system 800, IoT devices 855, 860 may be a washer and dryer, respectively, for residential use, being controlled by the virtual reality device 850. Accordingly, while the user of the virtual reality device 850 may be in different room of the building 810, the user may control an operation of the IoT device 855, such as configuring a washing machine setting. Virtual reality device 850 may also control the networked entertainment device 865. For example, virtual reality device 850 may broadcast a virtual game being played by a user of the virtual reality device 850 onto a display of the networked entertainment device 865.

The small cell 830 or any of the devices of building 810 may be connected to a network that provides access to the Internet and traditional communication links. Like the system 700, the wireless communications system 800 may facilitate a wide-range of wireless communications connections in a 5G system that may include various frequency bands, including but not limited to: a sub-6 GHz band (e.g., 700 MHz communication frequency), mid-range communication bands (e.g., 2.4 GHZ), and mmWave bands (e.g., 24 GHZ). Additionally or alternatively, the wireless communications connections may support various modulation schemes as described above with reference to system 700. Wireless communications system 800 may operate and be configured to communicate analogously to system 700. Accordingly, similarly numbered elements of wireless communications system 800 and system 700 may be configured in an analogous way, such as communication device 720 to communication device 820, small cell 730 to small cell 830, etc.

Like the system 700, where elements of system 800 are configured to form independent hierarchal or ad-hoc networks, communication device 820 may form a hierarchal network with small cell 830 and mobile device 815, while an additional ad-hoc network may be formed among the small cell 830 network that includes drone 817 and some of the devices of the building 810, such as networked workstations 840, 845 and IoT devices 855, 860.

Devices in wireless communications system 800 may also form (D2D) connections with other mobile devices or other elements of the wireless communications system 800. For example, the virtual reality device 850 may form a narrowband IoT connections with other devices, including IoT device 855 and networked entertainment device 865. As described above, in some examples, D2D connections may be made using licensed spectrum bands, and such connections may be managed by a cellular network or service provider. Accordingly, while the above example was described in the context of a narrowband IoT, it can be appreciated that other device-to-device connections may be utilized by virtual reality device 850.

In various examples, the elements of wireless communications system 800, such as the mobile device 815, the drone 817, the communication device 820, the small cell 830, the networked workstations 840, 845, the virtual reality device 850, the IoT devices 855, 860, and the networked entertainment device 865, may be implemented as part of any of the computing system 100 in FIG. 1, computing system 200 in FIG. 2, electronic device 300 in FIG. 3, computing system 400 in FIG. 4, or any system or combination of the systems depicted in FIGS. 1-4 described herein.

For example, the IoT device 860 may be implemented as the electronic device 300. The IoT device 855 may include a sensor to detect various acrodynamic properties of the drone 817 traveling through the air space. For example, the drone 817 may include a moisture sensor to detect a level of moisture of clothes in a residential dryer, such as IoT device 860. The IoT device 860 may provide the sensor data to processing units 111 that are configured to operate for an active time period and process the sensor data over a sequence of configurations partly based on a clock signal (e.g., a timer of virtual reality device 850) that the IoT device 860 receives from the virtual reality device 850 over a D2D connection. The IoT device 860 transmits a narrowband RF signal via the antenna 101 to the virtual reality device 850 with the sensor data that was processed by the processing units 111 implementing various processing stages, as described herein. The virtual reality device 850, receiving the narrowband RF signal, may display a visual representation of the drying status, such as a percentage bar, on an icon on a display of the virtual reality device 850, thereby updating the user of the virtual reality device 850 as to a status of the user's clothes in the IoT device 860. In implementing the electronic device 300 as part of the IoT device 860, the IoT device 860 may utilize less power, with the processing units 111 being active only during active time periods, thereby saving power during inactive periods.

Additionally or alternatively, while described in the examples above in the context of the IoT device 860, the elements of communication system 800 may be implemented as part of any of the computing systems disclosed herein, including: computing system 100 in FIG. 1, computing system 200 in FIG. 2, electronic device 300 in FIG. 3, computing system 400 in FIG. 4, or any system or combination of the systems depicted in FIGS. 1-4 described herein.

Certain details are set forth above to provide a sufficient understanding of described examples. However, it will be clear to one skilled in the art that examples may be practiced without various of these particular details. The description herein, in connection with the appended drawings, describes example configurations and does not represent all the examples that may be implemented or that are within the scope of the claims. The terms “exemplary” and “example” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Techniques described herein may be used for various wireless communications systems, which may include multiple access cellular communication systems, and which may employ code division multiple access (CDMA), time division multiple access (TDMA), frequency division multiple access (FDMA), orthogonal frequency division multiple access (OFDMA), or single carrier frequency division multiple access (SC-FDMA), or any a combination of such techniques. Some of these techniques have been adopted in or relate to standardized wireless communication protocols by organizations such as Third Generation Partnership Project (3GPP), Third Generation Partnership Project 2 (3GPP2) and IEEE. These wireless standards include Ultra Mobile Broadband (UMB), Universal Mobile Telecommunications System (UMTS), Long Term Evolution (LTE), LTE-Advanced (LTE-A), LTE-A Pro, New Radio (NR), IEEE 802.11 (WiFi), and IEEE 802.16 (WiMAX), among others.

The terms “5G” or “5G communications system” may refer to systems that operate according to standardized protocols developed or discussed after, for example, LTE Releases 13 or 14 or WiMAX 802.16e-2005 by their respective sponsoring organizations. The features described herein may be employed in systems configured according to other generations of wireless communication systems, including those configured according to the standards described above.

The various illustrative blocks and modules described in connection with the disclosure herein may be implemented or performed with a general-purpose processor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above are also included within the scope of computer-readable media.

Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

From the foregoing it will be appreciated that, although specific examples have been described herein for purposes of illustration, various modifications may be made while remaining with the scope of the claimed technology. The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A non-transitory computer readable medium comprising executable instructions that, when executed, a wireless communication device to:
receive signaling indicative of first data;
process, using a neural network, the first data to generate second data using a first configuration of one or more processing units selected from a set of configurations for the one or more processing units;
process, using the same neural network, the second data to generate a radio frequency (RF) signal using a second configuration of the one or more processing units that comprises a different configuration selected from the set of configurations for the one or more processing units; and
transmit the RF signal that is based on the second data.

2. The non-transitory computer readable medium of claim 1, wherein the second configuration includes a digital front-end processing stage, a radio frequency processor stage, or a combination thereof.

3. The non-transitory computer readable medium of claim 1, wherein the first configuration includes a source data processor stage, wherein the second configuration includes a baseband processor stage.

4. The non-transitory computer readable medium of claim 1, wherein the executable instructions further cause the wireless communication device to provide the signaling indicative of the first data from a sensor detecting an environmental characteristic.

5. The non-transitory computer readable medium of claim 1, wherein the executable instructions further cause the wireless communication device to transmit the RF signal at a frequency band corresponding to at least one of 1 MHz, 5 MHz, 10 MHz, 20 MHz, 700 MHz, 2.4 GHz, or 24 GHz.

6. The non-transitory computer readable medium of claim 1, wherein a time period comprising the receiving, processing, and transmitting, comprises an active time period of a discontinuous reception (DRX) or discontinuous transmission (DTX) cycle.

7. The non-transitory computer readable medium of claim 6, wherein the DRX or DTX cycle comprises an inactive time period designated for powering down one or more components of a device operation according to the DRX or DTX cycle.

8. The non-transitory computer readable medium of claim 1, wherein the processing using the different configurations is performed using one processing unit.

9. A non-transitory computer readable medium comprising executable instructions that, when executed, cause a wireless communication device to:
receive signaling indicative of sensor data;
contemporaneously, using a neural network in a first configuration:
process the sensor data via source data processing to provide first intermediate data; and
process the first intermediate data via baseband processing to provide output data; and
transmit a radio frequency signal that is based at least in part on the output data from the baseband processing.

10. The non-transitory computer readable medium of claim 9, wherein the sensor data is a first type, wherein the executable instructions further cause the wireless communication device to:
switch configurations of the neural network to a second configuration capable of supporting a second type of the sensor data; and
process the sensor data via source data processing using the second configuration.

11. The non-transitory computer readable medium of claim 10, wherein the first type of sensor data comprises audio, video, image, temperature, pressure, or acceleration data, and wherein the second type of sensor data comprises another of the audio, video, image, temperature, pressure, or acceleration data.

12. The non-transitory computer readable medium of claim 9, wherein a time period comprising the receiving, processing, and transmitting, comprises an active time period of a discontinuous reception (DRX) or discontinuous transmission (DTX) cycle.

13. The non-transitory computer readable medium of claim 12, wherein the DRX or DTX cycle comprises an inactive time period designated for powering down one or more components of a device operation according to the DRX or DTX cycle.

14. An apparatus comprising:
a sensor configured to receive input data;
an antenna configured to transmit a radio frequency (RF) signal that is based at least in part on the input data; and
one or more processing units coupled with the sensor and operable, during an active time period, to process the input data using a single neural network for a plurality of processing stages, the plurality of processing stages comprising an input data processing stage and communication processing stages.

15. The apparatus of claim 14, wherein the apparatus comprises one processing unit configured to use the input data processing stage and the communication processing stages to process the input data using the single neural network.

16. The apparatus of claim 14, further comprising:
a processing unit of the plurality of processing units, the processing unit comprising:
a multiplication unit configured to multiply a portion of the input with weight data to generate a processing result; and
an accumulation unit configured to accumulate at least the processing result to generate the output data.

17. The apparatus of claim 16, wherein the multiplication unit is further configured to multiply the output data with additional weight data to generate an additional processing result, and wherein the accumulation unit further configured to accumulate at least the additional processing result to generate additional output data.

18. The apparatus of claim 14, wherein the input data processing stage includes at least one of a source data processor stage, and wherein the communication processing stages include at least one of the baseband processor stage, or a digital front-end processing stage, or a radio frequency processor stage, or a combination thereof.

19. The apparatus of claim 14, wherein at least one of the one or more processing units, or the antenna is configured to operate in accordance with a wireless communication protocol that employs at least one of GFDM, FBMC, UFMC, DFDM, SCMA, NOMA, MUSA, or FTN, or any combination thereof.

20. The apparatus of claim 14, wherein the one or more processing units comprise components of at least one of a base station, small cell, mobile device, drone, communication device, a vehicle communication device, or a device configured to operate on a narrowband Internet of Things (IoT) frequency band.
